(19) United States
(12) Patent Application Publication
(10) Pub. No.: US 2007/0208638 A1
(43) Pub. Date: Sep. 6, 2007

(54) CONSUMER CREDIT FINANCE CASHFLOW FUNDING SYSTEM

(76) Inventor: Stephen Arthur Brown, Guilford (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/574,986

(22) PCT Filed: Oct. 6, 2004
(86) PCT No.: PCT/AU04/01355

§ 371 Date: Oct. 24, 2006

(30) Foreign Application Priority Data
Oct. 6, 2003 (AU) 2003905438

(51) Int. Cl. G06Q 40/00

(52) U.S. Cl. 705/35; 705/1

(57) ABSTRACT

A funding system including a local processor operable by a broker, the local processor including an input means to allow the broker to input data in respect of a funding request, and the local processor analysing the data using predefined rules to determine whether funding will be offered in response to the funding request; and wherein the local processor synchronises data with a central processor.

The present invention is directed towards the electronic processing of various financial instruments of funding, in particular the electronic processing of insurance premium funding services, professional fee funding services, membership fee funding services and retail funding services for merchants.

### BACKGROUND OF THE INVENTION

The present invention seeks to improve cashflow funding services presently available. Examples of such cashflow funding services include insurance premium funding services for insurance underwriters, intermediaries and brokers professional fee funding services for professionals such as doctors, dentists, accountants and lawyers; membership fee funding services for groups, associations and organisations and retail funding services for merchants and service providers.

Insurance Premium Funding is the term used to describe a form of finance which allows consumers to pay insurance premiums via an amortised installment program, thus enabling the insurance broker to receive immediate cashflow and the consumer to conserve working capital. Professional Fee Funding is the term used to describe a form of finance which allows the clients to pay for professional fees via an amortised installment program, thus enabling the professional to receive Immediate cashflow and the client to conserve working capital. Membership Fee Funding is the term used to describe a form of finance which allows the members of groups, associations and organisations to pay for membership fees via an amortised Installment program, thus enabling the group/association/organization to receive immediate cashflow and the member to conserve working capital. Retail Funding is the term used to describe a form of finance which allows the customers of a merchant or service provider to pay for goods and services via an amortised installment program, thus enabling the merchant/service provider to receive immediate cashflow and the customer to conserve working capital.

Consider the following insurance premium funding example of a small business with a “general” insurance premium of $5000. In order to assist with cash management, an insurance broker may arrange to amortise this premium over a set period of time, for example 10 months. The insurance broker may add a margin in order to provide the service, the funder then adds an interest component, documentation fees and taxes where applicable and the total amount is then divided into 10 payments. This amount is then deducted from the consumer's account every month for the next 10 months.

The problem with traditional cashflow funding systems is that they utilise a cumbersome manual reconciliation of settlements for payments, and commissions, requiring an involved paper trail for all parties.

Utilising traditional cashflow funding systems, an insurance broker, professional, association or merchant (hereinafter referred to as the merchant) must manually calculate and complete contract paperwork for a client, then forward this paperwork to a head office/funder for approval and processing—all of which can take several days. At this time, the merchant has no information regarding the client's credit worthiness or acceptability for such funding. If approved, the head office/funder must then duplicate the client's data and enter the information into their own computer system and arrange for payments to be made, either manually or electronically. Communication between the merchant and the head office/funder is difficult and thus extremely limited, with the merchant being unaware of what payments and settlements have been performed on this contract.

These systems lack “immediate” credit control and approval systems, with limited “shared knowledge” of the consumer at the time of creating a client, particularly for businesses with multiple offices and/or loan personnel. As a result of this such systems are expensive to manage, incorporating high costs for the generation and organisation of loan documents, administration and management control.

Traditional cashflow funding systems are often simplistic, allowing for quotation and document generation only, with little ‘full life of loan’ application or integration into existing accounting solutions or third party services such as credit reference checking, debt collection. Further, traditional systems also do not allow for flexible payment methods such as supporting split payment facilities over several accounts, for example, a company with multiple divisions may require each division to pay a proportional part of the monthly payment.

In summary, traditional cashflow funding systems utilise either costly, time consuming manual systems, or antiquated computerised systems with limited flexibility and funding options, being limited to one type of funding only e.g. insurance premium funding. There is therefore a need for an improved system which is more time efficient, easy to use and ideally offers a number of funding solutions in the one system.

### OBJECTIVE OF THE INVENTION

An objective of the present invention is to provide a relatively simple system which is more time efficient then the existing manual systems, and provides a certainty of response for both merchants and consumers.

### SUMMARY OF THE INVENTION

With the above object in mind the present invention provides in one aspect a funding system wherein a consumer desiring service from a merchant seeks funding from at least one funding provider, said consumer entering into a loan arrangement with said funding provider to repay said funds. In one arrangement said funds may be guaranteed by said merchant.

In a further aspect the present invention provides a funding system including a local processor operable by a merchant, said local processor including an input means to allow said merchant to input data in respect of a funding request, and said local processor analysing said data using predefined rules to determine whether funding will be offered in response to said funding request; and wherein said local processor synchronises data with a central processor.

In some embodiments, said local processor may allow said merchant to request said predefined rules be overridden for said funding request. Further when said local processor synchronises with said central processor, said central processor performs settlement of said funding request. The local processor and central processor can also perform additional synchronisations allowing the merchant to view all settlement activity performed, including any commissions paid, which are associated with the funding request.

### BRIEF DESCRIPTION OF THE DRAWINGS

FIG. 1 shows the flow of information between the Local Merchant Application and the Remote Host Application and other third party agencies such as financial institutions and credit reference agencies, of the preferred embodiment.

FIG. 2 shows the database tables which make up the Local Merchant Application and Remote Host Application of the preferred embodiment.

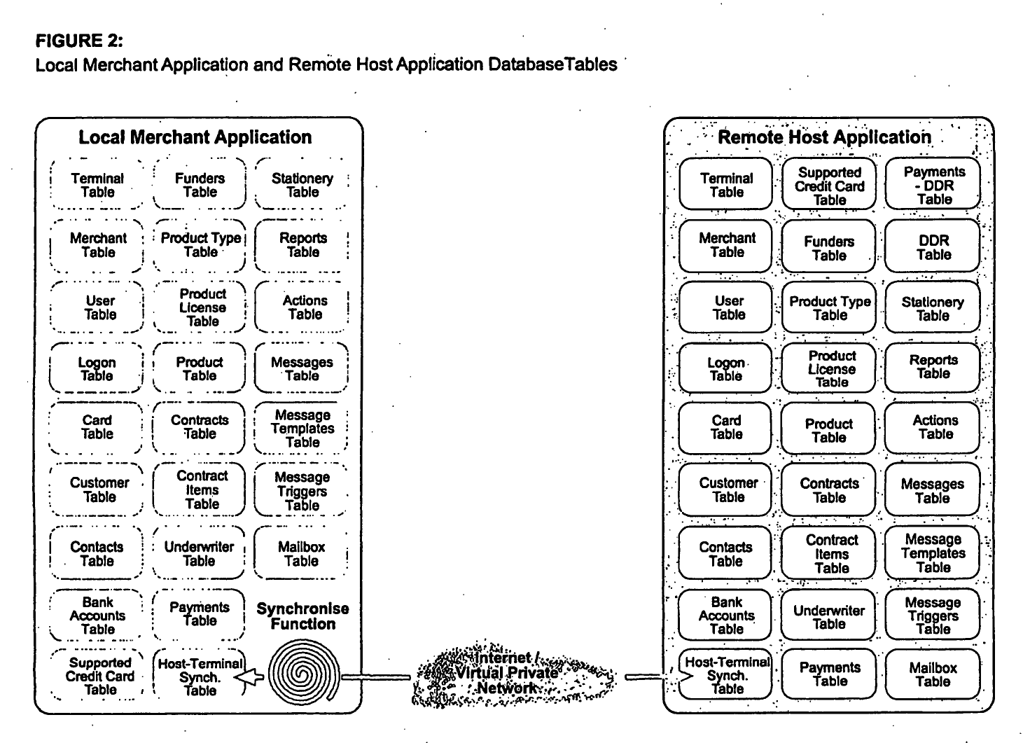

### DESCRIPTION OF PREFERRED EMBODIMENT

The present invention can include three main components, namely a Local Merchant Application, a Remote Host Application and a Web Interface Application, to enter, record and process customer, contract, payment and settlement transactions.

The Local Merchant Application resides on a merchant operator's computer system, allowing the operator to enter, record, process and recall information before forwarding data to the Remote Host Application using the synchronisation process.

The Local Merchant Application is available in two configurations; single user (where the merchant uses a single application to enter, record, process and recall information) or client server (where the merchant may use multiple instances of the application which connect to a local server to enter, record, process and recall information) before forwarding data to the Remote Host Application.

The Local Merchant Application includes a number of database tables where customer, contract, system rules and parameters can be stored. Data is entered into these tables by means of GUI (graphical user interface) data entry screens, allowing the merchant operator to enter the relevant data into labelled fields, or select data from pre-coded lists, which is then saved, processed and recorded in the applicable database tables. Data is also able to be retrieved or accessed from these tables by means of GUI list screens, allowing the Merchant operator to search, filter, graph or report the relevant data recorded in the database tables.

The Local Merchant Application enables the Merchant operator to enter and create customers, quotations and contracts according to certain rules and parameters stored on the Local Merchant Application. The customer, quotation or contract can be initially validated and either accepted or declined by the Local Merchant Application, or referred to the Remote Host Application for approval.

For example, the merchant enters a customer's details into the Local Merchant Application, along with details of the goods and/or services to be funded, and selects the terms and fees that will be offered to the customer.

After selecting the required schedule length e.g. 3 months, 6 months or 12 months, and installment periods e.g. weekly, fortnightly, monthly, the merchant can nominate whether the customer will incur the credit charges for the loan contract or whether these will be absorbed by the merchant.

The Local Merchant Application can then produce a quotation for the customer, displaying the details of the goods and/or services to be funded, the term of the loan, fees and charges associated with the loan and a summary of the repayments for the loan. If the quotation does not meet the criteria of certain rules and parameters maintained on the Local Merchant Application, the operator is notified that the quotation is unable to be accepted.

If the customer wishes to go ahead with the quotation, the merchant electronically converts the quotation to a contract. The merchant then enters the details of the customer's nominated payment method for the contract. If a guarantor is required according to the funding rules for this contract, the merchant can enter the details of the guarantor into the application. If the contract does not meet the criteria of certain rules and parameters maintained on the Local Merchant Application, the operator is notified that the contract will not be accepted.

The application will then produce a legal and binding contract displaying the goods and/or services to be funded, the terms and conditions, scheduled payment dates, installment amounts and any relevant fees. If a guarantor or additional signatories were required for the contract, the relevant forms will also be printed with the contract.

When satisfied, the customer signs a copy of the printed contract. Upon electronic acknowledgement by the merchant that the contracts have been printed and signed by the customer, the Local Merchant Application will then synchronise with the Remote Host Application and forward the details of the customer and the contract to the Remote Host Application for final approval and processing.

According to certain rules and parameters stored on the Remote Host Application, the customer and contract data is then validated and authorised by performing velocity error checks on each transaction. For example, a new contract is sent to the Remote Host Application which requires a credit check to take place on the customer. The R emote Host Application will check to see if an existing credit report exists for this customer, if not the Remote Host Application will forward an electronic request to a credit ratings agency for a credit report on this customer. When the credit report and credit score of the customer is returned, based upon rules and parameters set up on the Remote Host Application, the customer will be approved or declined for funding.

Other velocity checks which may take place include checking to see if the customer in question has existing contracts with this Merchant, or other Merchants, and whether a history of rejected or defaulted payment transactions exists for this customer.

If approved, the contract is then processed by the Remote Host Application which can perform the electronic settlement of all contracts and payment schedules between all related parties (client, funder, merchant, bank), deducting the regular payment installments from the client's preferred bank account on the nominated dates and depositing these directly into the funder's trust account, whilst providing full reporting to all stakeholders.

Should a payment fail, the system will automatically notify the customer of the default, create additional default fees and perform automatic re-submissions at a set later date. In the case of serious defaults, the system will forward delinquent accounts to a nominated debt collection service, notifying all stakeholders of the outcome.

The Remote Host Application resides on a remote computer server/s and is capable of storing a vast number of individual records and databases for a vast number of merchants. As such, the Remote Host Application may be ‘split’ or situated on a number of computer servers in order to provide the required load balancing.

Each merchant's data (stored in database tables on each Local Merchant Application) is replicated in full on the Remote Host Application in a series of Master Database Tables. The Remote Host Application performs the ‘validation’ and ‘replication’ of Merchant data using a unique ‘synchronisation’ process and then performs the electronic settlement or ‘transaction automation’ of all payment transactions. These four functions are outlined in further detail below.

The Invention's unique synchronisation methodology currently utilises TCP/IP technology and a custom designed ‘synchronisation protocol’ technology to forward information which has been stored on the Local Merchant Application to the Remote Host Application for processing and replication, and vice versa.

TCP/IP (Transmission Control Protocol/Internet Protocol) is the basic communication language or protocol of the Internet. It can also be used as a communications protocol in a private network (either an intranet or an extranet). TCP/IP is a two-layer program. The higher layer, Transmission Control Protocol, manages the assembling of a message or file into smaller packets that are transmitted over the Internet and received by a TCP layer that reassembles the packets into the original message. The lower layer, Internet Protocol, handles the address part of each packet so that it gets to the right destination.

Application protocols that also use TCP/IP include the World Wide Web's Hypertext Transfer Protocol (HTTP), the File Transfer Protocol (FTP), Telnet which allows a person to logon to remote computers, and the Simple Mail Transfer Protocol (SMTP) which is used when sending emails.

The ‘synchronisation protocol’ runs In conjunction with TCP/IP technology to enable the Local Merchant Application to connect to the Remote Host Application using a telecommunication method such as the Internet or via a VPN. Synchronisation is initiated by the Local Merchant Application, with the Remote Host Application detecting any such synchronisation.

In brief, for the preferred system all synchronisations are initiated by the Local Merchant Application. When a synchronisation is initiated, the Local Merchant Application accesses the Host-Terminal Synchronisation Database Table which automatically records any new or modified data created in the application (either entire records or individual fields within a record) and uploads this information to the Remote Host Application.

Conversely, when a synchronisation is initiated by the Local Merchant Application, any new or modified data created by the Host and stored in the Host-Terminal synchronisation Database Table on the Remote Host Application is downloaded to the Local Merchant Application, for example, downloading updates on rules and lending parameters controlled by the Host, modifications to lending rate tables, audit information, stationery templates used in the production of quotations, contracts, and reports, etc.

The synchronisation process is also used to exchange. ‘messages’ between the Local Merchant Application and the Remote Host Application, such as Merchant requests for lending limit increases, finance rate reductions, stamp duty processing and other lending exceptions and the responses that a Remote Host operator may return. This messaging functionality removes the need for physical contact between the Merchant operator and the Remote Host operator to approve or decline day-to-day processing and business decision requests.

In the preferred arrangement, as the Remote Host Application is capable of storing a vast number of individual records and databases for a vast number of Merchants, each sequence or string of information which is synchronised between a Local Merchant Application and the Remote Host Application contains a ‘header’ packet of data which can be used by the Remote Host Application to identify, authenticate and validate the credentials of the Merchant operator who sent it. The header can contain the unique identification code of the registered merchant, and the unique ‘terminal’ identification code of the individual Local Merchant Application.

In addition, every piece of system data sent in the sequence or string from the Local Merchant Application and attached to the header packet of data should contain a number of database table and record identification codes, allowing the Remote Host Application to replicate the data in the correct master database tables recorded at the Host. For example, if a particular contract is forwarded to the Remote Host Application when a synchronisation is performed, the contract data should contain the identification code of the database table it belongs to [TableID], a unique contract ID [ContractID] and the unique ID of the customer [CustomerID] that this contract belongs to.

The synchronisation protocol technology also uses a series of four letter commands to dictate the type of information which has been sent and what is required to be performed with this information. For example, if the four letter command ‘SYNE’ is sent by a Local Merchant Application to the Remote Host Application, the Remote Host Application may recognise this command as ‘the current synchronisation session has ended’.

The present invention has been designed to provide a level of security and functionality as that which is required by major global financial institutions. All data which is passed between the two applications via the Internet or a Virtual Private Network [VPN] is compressed and encrypted using 128 bit key encryption (the global standard for securitised encryption). It will be understood that security encryption can change with acceptable standards.

This method of synchronisation should also support conflict resolution on partially updated records or records which have been simultaneously updated on both the Local Merchant Application and the Remote Host Application.

In order to perform efficient and effective replication of each Merchant's data into the Master Database Tables stored on the Remote Host Application, the Remote Host Application uses two methods of functionality to perform the replication process; Relational Theory and Normalisation.

Relational Theory is the term given to the process by which information in each Master Database Table is attached or cross referenced with other records in other Master Database Tables to avoid the unnecessary duplication and reentry of data.

In order for Relational Theory to take place, each record in a Master Database Table is assigned a primary key (or identification code). In turn, each record within the Master Database Table may contain fields which have also been assigned primary keys which identify the Master Database Table they cross reference to.

For example, the Master Contracts Database Table may contain 3 contracts with primary keys of Contract001, Contract002, Contract003. The contract record identified as Contract001 has been created by a Merchant with a primary key of MerchantABC and is assigned to a customer with a primary key of CustomerSmith01. In turn, the Master Merchants Database Table will contain a record of the Merchant with the primary key of MerchantABC and the Master Customers Database Table will contain a record of the customer with the primary key of CustomerSmith01.

Normalisation is the process by which the Remote Host Application receives synchronised data from each Merchant and breaks the data down into individual pieces in order to be recorded in the appropriate master database tables.

As outlined in the Synchronisation section each sequence or string of information which is synchronised between a Local Merchant Application and the Remote Host Application contains a ‘header’ packet of data which is used by the Remote Host Application to identify, authenticate and validate the credentials of the Merchant who sent it. The header should contain the unique identification code of the registered Merchant organisation, and the unique ‘terminal’ Identification code of the individual local Merchant application.

In addition, every piece of system data sent in the sequence or string from the Local Merchant Application and attached to the header packet of data contains a number of database table and record identification codes, allowing the Remote Host Application to replicate the data in the correct Master database tables recorded at the Host. For example, if a particular contract is forwarded to the Remote Host Application when a synchronisation is performed, the contract data will contain the identification code of the database table it belongs to [TableID], a unique contract ID [ContractID] and the unique ID of the customer [CustomerID] that this contract belongs to. Also included in the record are the various data fields attached to the contract such as Loan Amount, Start Date, etc.

Once the sequence or string of information is validated by the Host, the Normalisation function takes place by identifying the primary keys (or Identification codes) within the string and replicating the data associated with these primary keys in the appropriate Master Database Tables. For example, the Normalisation function will recognise;
a) the contract's primary key and replicate all the contract information in the Master Contracts Database Table.
b) the customer's primary key associated with this contract and will replicate the customer in the Master Customer's Database Table.
c) the goods and/or services associated with this contract and will replicate this in the Master Contract Items Database Table.
   Utilising the process of Relational Theory, the Normalisation function will cross reference the primary keys of the merchant, customer and contract items within the Master Contracts Database Table and vice versa.

The Remote Host Application electronically performs all settlements between all stakeholders, including monitoring and processing all payments, utilising an electronic interface to an acquiring bank. This process is known as Transaction Automation and is outlined below. It will be understood that the example given is the settlement of a standard contract repayment, however many other settlements may take place such as the payment of commission for the contract to the merchant and the payment of monthly access fees from the merchant to the operators of the Remote Host application, etc.

On a daily basis, the Remote Host Application sweeps the Master Payments Database Table, detecting all scheduled payments for contracts which are to take place on this date. Each scheduled payment is in effect comprised of two payments. One is a debit transaction, removing the funds from the customers account, the other is a credit transaction where the funds are deposited into the funder's account.

The Remote Host Application then replicates the necessary information for each payment transaction, creating a new ‘batch’ of bank transfer records (known as Direct Debit Requests [DDRs]) in the Payment-DDR Database Table. At a given time each day, the ‘batch’ is converted to a sequence or string of data in a format which the acquiring bank accepts.

The acquiring bank then performs the necessary debit and credit transactions and returns a sequence or string of data to the Remote Host Application. This data is a DDR file and contains the individual direct debit details of the payments which have taken place, including whether they where performed successfully or not. The Remote Host Application then replicates each direct debit record and its outcome from the DDR file into the DDR Database Table. These records are later downloaded to each appropriate Local Merchant Application when synchronisation is next performed.

The Web Interface Application is a ‘cut down’ Internet based version of the Local Merchant Application which enables merchants to remotely access their own datafiles and create prospects, customers, quotations, contracts and messages (SMS, email, and fax) via the Internet from any computer or location via a web browser.

The Remote Host operator can download the GUI (graphical user interface) screens of the Web Interface Application and a subset of the merchant's database tables taken from the master database tables stored on the Remote Host Application, onto the web via a HTML page generator allowing the merchant to enter, view, select and report on the stored data.

All transactions performed on the Web Interface Application are duplicated and recorded at the Remote Host Application. Upon the next synchronisation between the Remote Host Application and the Local Merchant Application, the transactions performed on the Web Interface Application are synchronised to the Local Merchant Application in order to update the merchants local datafiles.

As outlined earlier, each Local Merchant Application is comprised of a number of database tables in which customer, contract, system rules and parameters are entered and stored. Each merchant's database tables are replicated in full on the Remote Host Application in a series of Master Database Tables. The purpose and functionality of these database tables is outlined below in further detail.

The Terminal Database Table stores data related to each Merchant using the application. In order to use a Local Merchant Application, every merchant must first be registered with the Remote Host Application and receive an authorisation/registration code which is calculated from the registration details of the Merchant.

A registered merchant will also receive a Terminal Identification Code and a Merchant Identification Code. These two identification codes are encoded with every record created on each Local Merchant Application and are included with every batch of data forwarded to the Remote Host Application when a synchronisation is performed, allowing the Remote Host Application to identify, authenticate, record and process the data from each terminal (merchant application). The registration code and Terminal Identification Code of each merchant is stored in the Terminal Database Table.

The data stored in the Terminal Database Table of each Local Merchant Application is replicated in the Master Terminal Database Table stored on the Remote Host Application.

The Merchant Database Table also stores data related to the Merchant using the application, including the Merchant Identification Code, outlined above, which is created at the time of registration. The Merchant Database Table also stores the category type of the merchant and the settings or preferences for this merchant. Preferences are the nominated defaults and settings which will be used by the Merchant in the Local Merchant Application, such as the default commission percentage, minimum and maximum loan term allowed, minimum and maximum loan value allowed, default documentation fees to be charged, etc.

Whilst some of the defaults and preferences are entered by the operator when initially setting up the system and are forwarded to the Remote Host Application when the operator performs a synchronisation, other defaults and preferences may be set by the Remote Host application and are downloaded to the Local Merchant Application and recorded in the Merchant able when the operator performs the first synchronisation. A number of these defaults and preferences are visible to the operator whilst others are hidden and are used by the application only. When applicable, modifications to the Merchant able are downloaded during subsequent synchronisations.

The data stored in the Merchant Database Table of each Local Merchant Application is replicated in the Master Merchant Database Table stored on the Remote Host Application.

The User Database Table stores data related to each user, or operator, who has access to each Local Merchant Application and their associated system privileges. Every user is assigned a unique User ID and a password, which must be entered and validated when entering the Local Merchant Application in order to commence operating the system. The unique User ID and password is a security feature which prohibits unauthorised access to the application or application data.

In addition, each time data is entered into a system and saved, the unique User ID of the user who entered the data is recorded with the data. This feature allows data such as customers and quotations to be assigned to, and/or viewed, only by the authorised user.

Each user can be assigned system privileges for every function and screen in the application, controlling access for viewing and editing data privileges in the application. The primary user of the application is established as the ‘Administrator’, who retains access to all functions in the application, including the creation and setting of privileges for all other users.

The data stored in the User Database Table of each Local Merchant Application is replicated in the Master User Database Table stored on the Remote Host Application.

The Logon Database Table is closely related to the User Database Table and tracks the details of each user when they logon to the Local Merchant Application and when they logout, storing the date and time of each logon and logout. The Logon Database Table assists in preventing multiple users being logged on with the same username in a single session.

The Card Database Table functions as the ‘Address Book’ for each Local Merchant Application and stores the contact type, name, address and contact details (phone, fax, mobile, email, www address, etc.) of every person or business entered into the application, including each merchant's own contact details.

The Card Database Table can store multiple addresses (e.g. shipping, postal, home, business, etc.) for each customer and multiple contact details for phone, fax, mobile and email addresses. The Card Database Table also stores the nominated notification type of each contact entered into the system e.g. SMS, fax, letter, email.

The data stored in the Card Database Table of each Local Merchant Application is replicated in the Master Card Database Table stored on the Remote Host Application.

The Customer Database Table stores data related to every customer with whom the merchant does business such as the customers employment details, Identification details, date of birth, etc. Depending upon the customer type (e.g. individual, company, trust, partnership, etc.) the data required for entry into the application may vary.

Each customer is assigned a unique Customer Identification Code and these codes are stored in the Customer Database Table. The Customer Identification Code is recorded with every quotation, contract or payment assigned to the customer, and is cross referenced in other database tables, allowing the operator to search, filter and display data such as all quotations for a particular customer, all contracts for a particular customer, etc.

When a new prospect/customer is created by an operator, the application performs a number of velocity error checks on the Customer Database Table and Card Database Table for items such as the same name and contact details as that of another customer, before declining or accepting the new customer record.

Every new client entered into the system is initially assigned the status flag of ‘Prospect’. When a quotation for funding is accepted by the client, the client's status flag is converted to ‘Customer’. Alternatively, the operator may manually convert the prospect's status flag to Customer if desired.

For marketing purposes, the application also enables the operator to assign customers to specific Industries or groups (these categories are created and maintained by the operator on the Local Merchant Application). Customers can also be assigned any number of operator-defined keywords or marketing labels, allowing the operator to search and filter customers based upon these keywords.

Customers can also be assigned a ‘pre-approved’ credit limit. This limit is established by the operator of the Remote Host Application and will allow a quotation to take place outside of the normal lending ranges applied to a merchant. For example, if a pre-approved credit limit of ‘0’ is recorded in the Customer Database Table for a particular customer, the application will ignore the field and use the standard quotation limit ranges when creating a quotation. If a value is entered into the pre-approved credit limit field, the application will consider this value when creating a quotation. A factor that may affect the pre-approved credit limit is the current balance (stored in the Local Merchant Application and updated at the time of synchronisation) of the customer's contracts, as the customer may have existing contracts which will then exceed the preapproved credit limit.

The Customer Database Table also records the details of the customers previously stamped stamp duty payments. If the customer has existing contracts with the Merchant and an existing funder, the amount of stamp duty already paid to the funder is recorded in the Customer Database Table and is automatically displayed on the quotation screen and taken into account when calculating stamp duty for the contract.

If the Merchant is creating a quotation on behalf of a customer using a particular funder and the customer claims they have previously paid stamp duty to this funder in a previous loan transaction generated by a non-related party elsewhere, the Merchant may perform a Stamp Duty Adjustment Request.

Note, as this procedure must be authorised by the customer, the application will automatically generate the appropriate form which must be signed by the customer. The application will also request acknowledgement from the Merchant that the authorisation form has been signed and executed correctly. The Stamp Duty Adjustment Request is then synchronised to the Remote Host Application, along with the details of the previous stamp duty payment.

The Remote Host operator will make enquiries with the funder as to when the stamp duty was paid and the amount paid. If verified, the Remote Host operator will insert the details of the previous stamp duty payment into the customer's record on the Master Customer Table held at the Host and download this information to the Merchant, updating the Local Merchant Application with the customer's new stamp duty data. The Remote Host Application will forward an electronic message to the Merchant, notifying that the Stamp Duty Adjustment Request has been approved or rejected.

If Membership Fee Funding is to be performed using the application, customers can be assigned a membership number. A unique ‘starting’ membership number is created by the Remote Host Application, with the ability to select some or all of the Merchant's customers in order to assign them with a membership number. This ‘default’ membership number will be automatically displayed when entering a customer's membership screen, however the Merchant can override this number and manually allocate a membership number to the customer.

Customers can also be assigned a membership credit limit and membership ‘start’ and ‘expiry’ dates, allowing the application to display whether the customer is a current or expired member.

From the customer screen, Merchants can also create and view operator ‘Notes’ which are assigned to each customer. The Local Merchant Application creates two types of notes; operator notes and system notes. Operator notes are created by an operator using the Local Merchant Application. Recorded with each operator note is the customer's unique ID code, the operator's User ID and the date and time that the note is created. System notes are created automatically by the Local Merchant Application and act as an audit log of the customers record. Each time the customer's record is modified, e.g. a payment method for the customer is altered, the details of the modification are recorded along with the User ID of the operator who performed the modification and the date and time the modification was performed. Although all operator and system notes are recorded in the Actions Database Table, only operator notes are able to be viewed on the Local Merchant Application.

The data stored in the Customer Database Table of each Local Merchant Application is replicated in the Master Customer Database Table stored on the Remote Host Application.

The Contacts Database Table stores the details of any number of contacts which are assigned to a customer. For example, if the customer is a business or company, any number of contact people at the business and their individual contact details can be assigned to this customer and are recorded in the Contacts Database Table, along with marketing information specific to this contact.

Other contacts associated with a customer may include guarantors. For example, at the time of creating a contract, according to the individual lending rules of each funder it may occur that a customer's contract may only be approved if a suitable guarantor accepts responsibility for the contract.

If the customer already has a number of associated contacts, the operator selects the required guarantor from the list field on the relevant contract screen (the list field is linked to the Contacts Database Table and displays all contacts which have been linked to this customer and which are recorded in the Contacts Database Table). If no guarantor has been created for this customer, the operator must create a new contact via the customer's Contact GUI screen. When saved, this guarantor's details will be recorded in the Contacts Database Table.

At the time of printing a contract, if guarantor forms are also required to be printed for signing, the application will automatically retrieve the nominated guarantor's data from the Contact Database Table and Insert this into the guarantor documentation.

Similarly, if the customer requires additional signatories for bank accounts, etc. these are entered and recorded in the Contact Database Table.

The data stored in the Contacts Database Table of each Local Merchant Application is replicated in the Master Contacts Database Table stored on the Remote Host Application.

The Bank Accounts Database Table stores the details of every bank or financial institution with whom each merchant and its customers may do business. The branch name, address and BSB of all banking and financial institutions are maintained by the Remote Host Application. This data is supplied with the first deployment of the application and maintained thereafter with regular updates.

The Bank Accounts Database Table is utilised by each Local Merchant Application when the Merchant initially sets up the commission, settlement and trust bank accounts which will be used by the Merchant. The Bank Accounts DatabaseTable is also used to record any number of ‘payment methods’ which may be used by each customer when making contract payments.

Customer payment methods can be created by the operator when entering a new customer, or on the fly at the time of creating a contract. When creating a payment method for a customer, the operator selects the name of the bank or the BSB number from the list field shown on each relevant screen (the list field is linked to and displays all banks listed in the Bank Accounts Database Table) and selects the nominated bank. The fields are filled in automatically and the operator then enters the relevant account number.

If the customer already has payment methods created the operator selects the required payment method from the list field (the list field is linked to the Bank Accounts Database Table and displays all payment methods which have been assigned to this customer, (recognised by the customer's identification code) and which are recorded in the Bank Accounts Database Table).

Customers may also nominate to perform a ‘split payment’ on one or more scheduled payments by assigning a percentage or set dollar figure of each payment to individual payment methods. For example, a business client may have a monthly scheduled payment of $2,500 per month. The business wishes to ‘split’ the monthly scheduled payments between two of its branch localities with Branch A paying 50% of the payment from Bank Account A and Branch B paying 50% of the payment from Bank Account B. By creating two different payment methods (one for Bank Account A and one for Bank Account B) the operator can split the monthly scheduled payments between the two. Each monthly scheduled payment would then comprise a debit of $1,250 from Bank Account A and another debit of $1,250 from Bank Account B.

The application also allows the customer to change the nominated payment method they are using to make scheduled payments, or to pay one or more scheduled payments with a different payment method.

The data stored in the Bank Accounts Database Table of each Local Merchant Application is replicated in the Master Bank Accounts Database Table stored on the Remote Host Application.

The Supported Credit Card Table stores data related to each credit card provider accepted by the Remote Host Application and with whom the Remote Host Application is able to perform settlement with.

When initially setting up the system, the Merchant nominates which credit card providers stored in the Supported Credit Card Table the Merchant will accept, for example, the Merchant may choose to accept Visa and Mastercard but not Amex or Diners. The nominated credit cards and card charges, etc. are downloaded to each Local Merchant Application and recorded in the merchant's Supported Credit Card Table when the operator performs the first synchronisation. If applicable, modifications to the Supported Credit Card Table are downloaded during subsequent synchronisations.

At the time of creating a contract, if the customer has nominated to make the scheduled payments with a credit card, the application will cross reference the selected payment method from the Bank Accounts Database Table, (i.e. Payment Method=Visa Card), with the Supported Credit Card Table to calculate the merchant fees and card charges for the credit card payments. These charges can then be incorporated into the contract value or, at the election of the Merchant, deducted from the commission paid to the Merchant or charged to the Merchant if no commission is to be paid.

As the present invention is capable of handling and processing contract funding from multiple funders using the one application, the Master Funders Database Table stores data related to each funder with whom the operator of the Remote Host Application has contract funding arrangements in place.

The invention allows for three methods of processing on behalf of funders and enables each funder to nominate one of these methods for processing;

a) Where the Merchant performs the initial ‘introduction and paperwork’ on the Local Merchant Application, with the Remote Host Application forwarding an electronic settlement file to the funder, who will then perform its own direct debits and settlements.

b) Where the operator of the Remote Host Application performs an end-to-end solution for a funder by performing all the quotation generation, contract generation, settlement and collection on behalf of the funder.

c) Where the Merchant has the ability to ‘self fund’ his own book of business. In this case, the Merchant becomes the funder and utilises his own pool of funds to fund non-approved contracts, up to a set credit limit. The invention performs an end-to-end solution for the Merchant/funder by performing all the quotation generation, contract generation, settlement and collection on behalf of the Merchant/funder.

The Master Funders Database Table also stores an individual set of rules for each funder, for example Funder A may require that only one party must sign contracts at the time of acceptance whereas Funder B may require all parties to sign contracts.

Each funder with whom the operator of the Remote Host Application has a contract funding arrangement in place, is set up on the Remote Host Application with the ability to fund at least one contract funding type e.g. Insurance Premium Funding, Professional Fee Funding, Membership Fee Funding, Retail Funding, etc. These contract funding types are known as ‘Product Types’. Some funders may offer only one product type, other funders may offer many.

As an example, a funder may offer the Product Type of Insurance Premium Funding [IPF]. Underneath this Product Type, the funder may have several individual ‘Products’ created such as contract funding for IPF of amounts less than $25,000, contract funding for IPF for amounts greater than $25,000 and contract funding for IPF for Government Departments, etc.

If a merchant wishes to offer a particular contract funding type on the merchant's Local Merchant Application, the merchant is assigned a Product License for each product required. The relevant Funder's details are then downloaded from the Master Funder Database Table and replicated in the Merchant's Funder Database Table stored on the Local Merchant Application.

The Master Product Type Database Table stores the details of the individual contract funding types available for use in the system such as Insurance Premium Funding, Professional Fee Funding, Membership Fee Funding, Retail Funding. Each of the product types has individual rules and settings which may apply to this product type only. In addition, each of the Product Types uses separate GUI screens for data entry when creating quotations and contracts and separate calculation methods when calculating interest charges for contracts, etc.

When a Product License is issued to a merchant for a product, the relevant Product Type details of this product are downloaded from the Master Product Types Database Table and replicated in the Merchant's Product Types Database Table stored on the Local Merchant Application.

The Master Product License Database Table records which products are licensed to each merchant, including the license and management fees charged to the merchant for using the product. When a product is licensed to a merchant, the details of each product (recorded in the Product Database Table) and standard product defaults are downloaded to the Merchant at the time of synchronisation. Alternatively, the standard product defaults can be modified for each merchant and downloaded to the Merchant.

If the Merchant is licensed to use multiple products, at the time of creating a quotation the Merchant may select from a list of the products available. The appropriate quotation GUI screen for the selected product will then display.

The Master Product Database Table stores the details of every Product belonging to a Product Type (contract funding type) including the Cost of Funds charged by the funder and the associated margins on Flat Rates charged to the customer for each contract under this Product. The Cost of Funds and Flat Rates information are used throughout the Local Merchant Application to calculate the finance charges on all quotations and contracts.

When a Product License is issued to a merchant for a product, the relevant Product details of this product are downloaded from the Master Product Database Table and replicated in the Merchant's Product Database Table stored on the Local Merchant Application.

Other product data includes lending rules which apply to this product when performing funding quotations and contracts. Rules are created as a series of ‘IF, THAN, AND/OR, NOT, ELSE’ statements and apply to features such as credit checking, use of guarantors, contract values, etc. For example, a lending rule may be created for a product that only allows contracts with a value of under $25,000 to be funded.

At the time of creating a quotation or contract for a particular product, the application will automatically perform a cross reference against the lending rules recorded in the Products Database Table for this product for any general conflict or specific funder conflict. If an appropriate system rule is found e.g. a guarantor is required for the contract, the application will display a system warning or notification to the operator that this must take place before the quotation or contract is concluded.

In the case of products where a physical asset cannot be used as security against the loan (such as Professional Fee Funding, Membership Fee Funding and in some cases Retail Funding) the Remote Host operator may nominate to hold a retention amount when performing settlement of these contracts. For example, if a retention amount of 20% has been nominated for a professional fee funding contract of $5,000 the system would settle $4,000 to the merchant immediately and then pay 6 installments of $166.66 to the merchant over a number of months. These retention settings are recorded in the settings for the appropriate product and recorded in the Product Database Table.

Other details stored in the Product Database Table for each product include banking and fee data related to each funders bank processing charges and any fees which apply to this Merchant when performing funding quotations and contracts such as transaction fees, rejection fees, quotation, contract, documentation and credit checking fees.

When a product is initially licensed to a Merchant, a default set of fees and charges is applied to the Merchant. Once configured by the Remote Host Application however, the fees and charges may vary from Merchant to Merchant depending upon loan size, loan duration and the frequency of business.

The banking and fees data enables the operator to accurately calculate the cost of processing fees and the profit of a contract, depending on the number of settlements to be made, payments to be processed, rejections for the life of the loan and any credit checks performed.

The Contracts Database Table stores the details of every quotation and contract created in the system and assigned to a customer (using the unique Customer Identification Code), such as customer details, loan start date, number of installments, associated invoice, contract item details e.g. insurance policy or description of goods and services, commission, stamp duty, fees and charges, an associated payment schedule for the contract and a list of settlements performed during the contract.

Every contract is first created as a quotation. At the time of creating a quotation, if the Merchant is licensed to use multiple funding products (recorded in the Products Database Table), the Merchant may select from a list of the products available e.g. Insurance Premium Funding, Professional Fee Funding, Membership Fee Funding, Retail Funding, etc. The appropriate quotation GUI screen for the selected product will then display. Note, the quotation and contract screens may differ slightly for each funding type.

When creating a quotation, the operator enters the details of the customer (an existing customer can be selected from a list field which is linked to the Customer Database Table or the operator can create a new customer at the time of creating the quotation.

The operator then enters the term of the loan and when the associated draw downs are to take place. If creating an Insurance Premium Funding quotation, the draw downs can be separated into cancellable and non-cancellable amounts. If creating a Professional Fee Funding quotation, Membership Funding quotation or Retail Funding quotation, the operator can enter a description of the fees, goods and/or services offered under this quotation or select the fees, goods and/or services from a pro-defined list (recorded in the Contract Items Database Table).

The operator may then choose to nominate whether the credit charges for the quotation/contract are to be paid by the customer or absorbed by the merchant. The Local Merchant Application then cross references the Product record for this funding type in the Product Database Table to determine the default commission, stamp duty, documentation fees and finance rates for the loan amount and calculates the total amount of the quotation.

A deposit may or may not be mandatory for each quotation and subsequent contract. This requirement is controlled by the Remote Host Application and forms part of the products lending rules, varying from Merchant to Merchant and funder to funder. The deposit may be either a percentage of the overall contract, a dollar value or set amount. If the deposit is paid directly to the Merchant by either cash or cheque, the application will deduct the deposit amount from the balance of the contract to be funded. If the deposit is to be paid via DDR, this value will be included with the funding contract and collected by the Remote Host Application as part of the first installment.

The Local Merchant Application will also automatically calculate and display other data associated with the quotation such as the Merchants overall ‘exposure’ for this quotation. For example, if creating an Insurance Premium Funding quotation for cancellable premium funding, the Exposure screen will display the refund amount the Merchant can expect to receive from the underwriter should the customer default on payment of the contract.

Prior to saving and accepting the quotation, the Local Merchant Application will perform a series of velocity checks, for example, cross referencing the amount of the loan against the Minimum and Maximum Loan Value settings recorded for this product in the Products Database Table to see if the loan amount fits the default criteria for this Merchant. The Local Merchant Application can also cross reference the Date of Birth field in the customer's record against the Minimum Customer Age field in the product record to ensure the customer fits the criteria. If an invalid entry is found, the application will notify the Merchant that the quotation cannot be accepted.

A quotation can be modified at any time until it is converted to a contract, with each modification being saved as a revision for viewing and editing, if required. Should the Merchant wish to print a copy of the quotation for the customer, the application retrieves the appropriate quotation template from the Stationery Database Table and prints out a copy of the quotation with the relevant details inserted.

Should the customer accept the quotation terms, the operator electronically converts the quotation to a contract, changing the status of the record from a quotation to a contract. Prior to converting a quotation to a contract, the application will perform a velocity check against the current date and the original date of the quotation, and cross reference this with the Quotation ate field recorded in the preferences for the merchant in the Merchant Database Table. If the quotation has expired, a warning message will be displayed to the Merchant. If desired, the Merchant may then copy the expired quotation to create a new quotation which can be converted to a contract

If creating an Insurance Premium Funding contract, the Merchant must assign an insurance policy or policies to the contract. The operator selects the required underwriter from a list field (the list field is linked to and displays all underwriters listed in the Underwriter Database Table) then enters the policy number and details of the policy.

The system will then cross reference the lending rules records in the Product Database Table to ensure that the ratio of cancellable and non-cancellable premiums falls within the parameters configured by the Remote Host Application e.g. a lending rule may exist where non-cancellable insurance may only account for a maximum of 50% of the contract value. If approved, the new Insurance policy/policies will be recorded in the Contract Items Database Table.

If creating a Professional Fee Funding, Membership Fee Funding or Retail Funding contract, the Merchant must assign an invoice for the fees, goods and/or services to be funded to the contract. The Merchant enters the date, amount and invoice number of the relevant invoice. The Merchant then enters a description of the professional fees or goods and services covered by the invoice. This data is recorded in the Contract Items Database Table.

The Local Merchant Application will then cross reference the date of the invoice with the ‘Maximum Invoice Age’ field recorded in the settings for this Product in the Products Database Table to see if the Invoice falls within the correct funding guidelines, e.g. the invoice must be less than 90 days old. If the invoice date exceeds this field, the Local Merchant Application will not allow the contract to be created. The system will also cross reference the lending rules of the Product to ensure that the ratio of professional fees to goods and services, and vice versa, falls within the parameters allowed e.g. a lending rule may exist where goods and services may only account for a maximum of 50% of the contract value.

When creating a contract, the customer must nominate a payment method which will be used to make the scheduled payments for the contract. If the customer already has payment methods created, the Merchant selects the required payment method from a list field (the list field is linked to the Bank Accounts Database Table and displays all payment methods which have been assigned to this customer, using the customer's unique ID code, and which are recorded in the Bank Accounts Database Table). If no payment method has been created for this customer, the operator must create a new payment method which will be recorded in the Bank Accounts Database Table.

Customers may also nominate to perform a split payment on one or more scheduled payments by assigning a percentage or set dollar figure of each payment to individual payment methods. For example, a business client may have a monthly scheduled payment of $2,500 per month. The business wishes to ‘split’ the monthly scheduled payments between two of its branch localities with Branch A paying 50% of the payment from Bank Account A and Branch B paying 50% of the payment from Bank Account B. By creating two different payment methods (one for Bank Account A and one for Bank Account B) the operator can split the monthly scheduled payments between the two. Each monthly scheduled payment would then comprise of a debit of $1,250 from Bank Account A and another debit of $1,250 from Bank Account B.

The customer may also nominate for the contract to include an auto roll-over option, where, in the case of annual or repeating insurances, services, etc. the contract will be automatically renewed upon expiry. Auto rollovers are like revolving lines of credit. Prior to the contract expiring, as defined in the merchant preferences, the application will notify the operator in the Task Manager that an auto rollover exists for the contract. The application automatically copies the original contract and creates a new quotation. If the insurance premium/professional fees/goods and services have increased or decreased, the merchant can enter the new amount and then convert the quotation to a contract. As the auto rollover function has been nominated by the customer, the contract does not have to be re-printed and signed. The application will also send a notification by letter or email to the customer advising them of the new contract commencement date and the amount of repayments.

From within the quotation and contract screens, Merchants can also create and view operator ‘Notes’ which are assigned to each customer. The Local Merchant Application creates two types of notes; operator notes and system notes. Operator notes are created by an operator using the Local Merchant Application. Recorded with each operator note is the customer's unique ID code, the quotation/contract ID code, the operator's User ID and the date and time that the note is created. System notes are created automatically by the Local Merchant Application and act as an audit log of the customer's quotation/contract. Each time the customer's quotation/contract is modified or printed, e.g. a payment method for the customer is altered, the details of the modification are recorded along with the User ID of the operator who performed the modification and the date and time the modification was performed. Although all operator and system notes are recorded in the Actions Database Table, only operator notes are able to be viewed on the Local Merchant Application.

Prior to saving and accepting the contract for processing, the application will perform a series of velocity checks against the customer. For example, the application will cross reference the Contracts Database Table to see if the customer has existing contracts with the Merchant. If existing contracts are found, the application will cross reference the Credit Limit field in the Customers Database Table to check if the new contract and balance of the existing contracts exceeds the customer's credit limit.

If the contract is accepted by the Local Merchant Application and is to be sent to the Remote Host Application for processing, the application will create new entries in the Payments Database Table with the dates, amounts and nominated payment method for each repayment under this contract.

The system will also print a number of mandatory contract documents by retrieving the appropriate contract templates from the Stationery Database Table such as contract form, terms and conditions form, guarantor's form, etc and print out a copy of the documentation with the relevant details inserted for signing by the customer.

Prior to synchronising the contract with the Remote Host Application, the Local Merchant Application will prompt the Merchant to electronically acknowledge that the customer has viewed and signed all the appropriate contract documentation such as the contract itself, the terms and conditions and credit checking authorisation forms.

The application will display a number of Yes/No questions such as ‘Has the contract been printed?’ and ‘H as the contract been signed’. If the Merchant answers Yes to the questions, the user ID and date and time of the Merchant's acknowledgement is recorded by the application in a system note which is assigned to the customer and recorded in the Actions Database Table. The contract is then saved and synchronised with the Remote Host Application for processing.

If the Merchant answers ‘No’ to any of the questions, the contract is saved and synchronised with the Remote Host Application but is not yet approved for processing. For example, if the contract has been printed but not yet signed by the customer, the contract is flagged as unsigned. Any outstanding tasks associated with this contract will appear in the Task. Manager and are also visually displayed as outstanding on the contract screen, until the Merchant acknowledges that the tasks have been completed by answering Yes to the electronic acknowledgement questions.

If the contract is not signed and executed within the default expiry period set up in the Merchant's Preferences, the application will automatically detect and notify the Merchant that the contract has expired and therefore the finance rates used may no longer be accurate. In this case, the Merchant can copy the original quotation in order to create a new quotation with the latest finance rates and convert this quotation to a contract for signing.

Once a contract has been signed and acknowledged by the Merchant as executed, a synchronisation is then performed between the Local Merchant Application and the Remote Host Application, forwarding the new or modified contract data to the Remote Host application, where further velocity checks may take place.

If the contract is accepted by the Remote Host Application after the additional velocity checking takes place a copy of the contract is replicated in the Master Contracts Database Table stored at the Host. In addition, new entries detailing the schedule payments for this contract will be created in the Master Payments Database Table stored at the Host.

Alternatively, at the time of saving a contract, the Merchant may opt to perform a ‘real-time velocity check’ of the contract. In this instance the Merchant must be ‘online’ (connected to the internet), allowing the Local Merchant Application to connect to the Remote Host Application and perform all the necessary velocity error checks on the contract immediately. If approved, the contract moves from a pre-approved state to an approved state. The ability to perform ‘real time velocity checking’ will be based on rules configured by the Remote Host Application and will be funder dependent, varying from funder to funder and Merchant to Merchant. It may also require the system to perform a real-time check with the credit reference agency and thus may take some time.

The Contract Items Database Table stores the details of every insurance policy, invoice or goods and services attached to a contract.

When creating an Insurance Premium Funding contract, the Merchant must assign an insurance policy or policies to the contract. The Merchant selects the required underwriter from a list field (the list field is linked to and displays all underwriters listed in the Underwriter Database Table) then enters the policy number and details of the policy. The Merchant may also nominate for the underwriter to receive settlement for the policy when the first scheduled payment is performed, or for the settlement amount to be paid to the Merchant on the underwriter's behalf.

The system will then cross reference the lending rules for this product to ensure that the ratio of cancellable and non-cancellable premiums falls within the parameters allowed e.g. a lending rule may exist where non-cancellable insurance may only account for a maximum of 50% of the contract value. If approved, the new insurance policy/policies will be recorded in the Contract Items Database Table.

When creating a Professional Fee Funding, Membership Fee Funding and Retail Funding contract, the Merchant must assign an Invoice for the goods and/or services to be funded to the contract. The Merchant enters the date, amount and invoice number of the relevant invoice. The Merchant then enters a description of the professional fees or goods and services covered by the invoice. This information is recorded in the Contract Items Database Table.

The system will then cross reference the date of the invoice with the ‘Maximum Invoice Age’ field configured in the lending rules for this product to see if the invoice falls within the correct funding guidelines, e.g. the invoice must be less than 90 days old. If the Invoice date exceeds this field, the application will not allow the contract to be created. The system will also cross reference the lending rules for this product to ensure that the ratio of professional fees to goods and services, and vice versa, falls within the parameters allowed e.g. a lending rule may exist where goods and services may only account for a maximum of 50% of the contract value.

The data stored in the Contract Items Database Table of each Local Merchant Application is replicated in the Master Contract Items Database Table stored on the Remote Host Application.

The Underwriter Database Table is utilised when creating contracts for Insurance Premium Funding only and stores data related to insurance underwriters with whom the Merchant may do business. The contacts, branch locations, classes of insurance (e.g. cancellable & non-cancellable) and premium bank account details (required when performing premium payments) of every insurance underwriter are maintained in the Master Underwriter Database Table by the Remote Host Application and are downloaded to the Local Merchant Application and recorded in the merchant's Underwriter Database Table when the operator performs the first synchronisation. When applicable, modifications to the Underwriter Database Table are downloaded during subsequent synchronisations.

When creating an Insurance Premium Funding contract on the Local Merchant Application, the Merchant must assign one or more insurance policies and underwriters to each contract. The operator selects the required underwriter from a list field (the list field is linked to and displays all underwriters listed in the Underwriter Database Table) and the branch and class of insurance. The operator also nominates whether the contract is to be settled directly with the Merchant or the underwriter.

When the contract is finalised and sent to the Remote Host Application for processing, the Remote Host Application identifies the specified underwriter (each underwriter in the Underwriter Database Table is assigned a unique ID code) and automatically settles the amount of the insurance policy premium to the underwriter's premium/trust bank account on the Merchant's behalf.

When the settlement has been performed, the Remote Host Application automatically notifies the underwriter of the settlement payment, electronically. In the event that the customer defaults on the contract, the Remote Host Application automatically notifies the underwriter to cancel the policy and requests a refund on the pro-rata balance of the contract.

The Payments Database Table stores the details of every scheduled payment attached to every contract in the system, such as the date of each Installment, amount of each installment, etc.

When a quotation is created, the application automatically calculates a schedule of payments for the quotation based upon the dates of the draw downs, the amount of the loan, the finance rate to be applied to the loan and any fees or charges which are associated with funding the loan. The schedule of payments is also based on default parameters listed in the settings for each product and recorded in the Product Database Table such as the Minimum and Maximum Loan Term.

For example, a customer requires funding for a contract of $25,000. This contract attracts a finance rate of 6.929% (or $1, 182.28) plus other documentation fees and charges totaling $712.50. The entire amount to be funded is calculated at $26,894.78. The date of the first draw down is entered as 10/01/2003. The application cross references the Maximum Loan Term field in the product settings which has been defaulted to 12 months and then calculates the scheduled repayments for this contract by dividing the amount to be funded of $26,894.78 into 12 equal monthly payments of $2,241.24, commencing on the 10/01/2003 and finishing on the 10/01/2004. (Note, this calculation takes into consideration that the Merchant has nominated for his commission to be paid evenly over the contract term and not in full with the first scheduled payment).

If the quotation is accepted and converted to a contract, the scheduled payments are recorded in the Payments Database Table (along with the ID code of the nominated payment method for this contract) and are outlined in full on the printed contract documentation.

When the contract is synchronised with the Remote Host application and approved for processing, the scheduled payments for this contract are replicated in the Master Payments Database Table of the Remote Host Application and are used to perform settlement of contract payments, as outlined below

On a daily basis, the Remote Host Application sweeps the Master Payments Database Table, detecting all scheduled payments for contracts which are to take place on this date. Each scheduled payment is in effect comprised of two payments. One is a debit transaction, removing the funds from the customer's account, the other is a credit transaction where the funds are deposited into the funder's account.

The Remote Host Application then replicates the necessary information for each payment transaction, creating a new ‘batch’ of bank transfer records (known as Direct Debit Requests [DDRs]) in the Payment-DDR Database Table. At a given time each day, the ‘batch’ is converted to a sequence or string of data in a format which the acquiring bank accepts.

The acquiring bank then performs the necessary debit and credit transactions and returns a sequence or string of data to the Remote Host Application. This data is a DDR file and contains the individual direct debit details of the payments which have taken place, including whether they where performed successfully or not. The Remote Host Application then replicates each direct debit record and its outcome from the DDR file into the DDR Database Table. These records are later downloaded to each appropriate Local Merchant Application when synchronisation is next performed.

In the case that a particular scheduled payment in the DDR Database Table is returned as rejected, the Remote Host operator can choose to re-schedule the payment in which case the Remote Host Application will insert a ‘re-scheduled payment’ (which may incorporate additional default fees and charges) for in the Master Payments Database Table. The Master Payments Database Table keeps a record of the number of rejection attempts for each scheduled payment. The re-scheduled payment is downloaded to the Payments Database Table on the Local Merchant Application when a synchronisation is next performed.

Alternatively, the Host operator may choose to issue the customer with a final notice or cancel the contract (if the re-scheduled payment has been attempted unsuccessfully a number of times). The Remote Host Application will then automatically notify the Merchant and the customer with the appropriate notifications.

The Payment-DDR Database Table is used by the Remote Host Application to process contract payments. On a daily basis, the Remote Host Application sweeps the Master Payments Database Table, detecting all scheduled payments for contracts which are to take place on this date. The Remote Host Application then replicates the necessary information for each payment transaction, creating a new ‘batch’ of bank transfer records (known as Direct Debit Requests [DDRs]) in the Payment-DDR Database Table. At a given time each day, the ‘batch’ is converted to a sequence or string of data in a format which the acquiring bank accepts and is sent to the acquiring bank for processing.

The DDR Database Table is used by the Remote Host Application to manage contract payments. After the acquiring bank has performed all the debit and credit transactions for each day's processing, the acquiring bank returns a sequence or string of data to the Remote Host Application. This data is a DDR file and contains the individual direct debit details of the payments which have taken place, including whether they where performed successfully or not. The Remote Host Application then replicates each direct debit record and its outcome from the DDR file into the DDR Database Table.

In the case that a particular scheduled payment in the DDR Database Table is returned as rejected, the Remote Host operator can choose to re-schedule the payment in which case the Remote Host Application will insert a ‘re-scheduled payment’ (which may incorporate additional default fees and charges) for in the Master Payments Database Table. The Master Payments Database Table keeps a record of the number of rejection attempts for each scheduled payment. The re-scheduled payment is downloaded to the Payments Database Table on the Local Merchant Application when a synchronisation is next performed.

Alternatively, the Host operator may choose to issue the customer with a final notice or cancel the contract (if the re-scheduled payment has been attempted unsuccessfully a number of times). The Remote Host Application will then automatically notify the Merchant and the customer with the appropriate notifications.

Host-Terminal synchronisation Database Tables are located on each Local Merchant Application and on the Remote Host Application. The Host-Terminal Synchronisation Database Tables are used to record any new or modified data created in each application, either entire records or individual fields within a record.

When a synchronisation is initiated by a Local Merchant Application, the application accesses the Host-Terminal Synchronisation Database Table stored on the Local Merchant Application and uploads all the data recorded in this database table to the Remote Host Application for replication and/or processing.

Conversely, when a synchronisation is initiated by the Local Merchant Application, any new or modified data created by the Host and stored in the Host-Terminal Synchronisation Database Table on the Remote Host Application is downloaded to the Local Merchant Application, for example, downloading updates on rules and lending parameters controlled by the Host, modifications to lending rate tables, audit information, stationery templates used in the production of quotations, contracts, and reports, etc.

The Host-Terminal Synchronisation. Database. Tables are also used to exchange ‘messages’ between the Local Merchant Application and the Remote Host Application, such as Merchant requests for lending limit increases, finance rate reductions, stamp duty processing and other lending exceptions and the responses that a Remote Host operator may return. This messaging functionality removes the need for physical contact between the Merchant operator and the Remote Host operator to approve or decline day-to-day processing and business decision requests.

The Stationery Database Table stores the templates of all stationery used in the production of quotations, contracts, terms and conditions documentation, guarantor forms, etc. for each product.

When a merchant is issued a Product License to use a funding product, the appropriate stationery templates are downloaded from the Master Stationery Database Table on the Remote Host Application to the Stationery Database Table on the Local Merchant Application.

Each stationery template recorded in the Stationery Database Table is assigned a unique template ID and product ID ensuring that the correct contract documentation for each product is accessed and printed by the Local Merchant Application.

The Local Merchant Application is able to automatically complete each template with the required data as each stationery template contains a default set of form data which is accessed from a particular database table (the form data and ID of the database table for each template is also recorded in Stationery Database Table). For example, a stationery template with the type ‘Contract’ is assigned to the Contracts Database Table and will retrieve and display the default set of form data for this contract from the Contracts Database Table.

In order to maintain the integrity of all stationery templates, all templates are created and maintained by the Remote Host Application. Any new or modified templates used by the merchant are downloaded to the Local Merchant Application and replicated in the Stationery Database Table on the Local Merchant Application when a synchronisation is next performed. If required, an authorised representative of the funder may ‘brand’ or customise form templates with the Merchant's logo.

The Reports Database Table stores the templates of all system reports used in the application. The Local Merchant Application is initially deployed with a number of system reports which are created and stored in the Master Reports Database Table by the Remote Host Application. Any new or modified templates are downloaded to the Local Merchant Application and replicated in the Reports Database Table on the Local. Merchant Application when a synchronisation is next performed.

In addition, the Merchant may create and edit new reports according to the Merchant's own requirements, which are assigned a name and unique ID and are also recorded in the Reports Database Table. Any report created and saved by the Merchant appears in the list of available reports to select from.

The Local Merchant Application is able to automatically produce each report with the required data as each report template contains a default set of form data which is accessed from a particular database table (the form data and ID of the database table for each template is also recorded in the Reports Database Table). For example, a report template with the type ‘Customers’ is assigned to the Customers Database Table and will retrieve and display the required form data for this report from the Customers Database Table. Additional data may also be accessed from other tables in the application.

The system can incorporate a feature named Actions, which enables merchants to assign an ‘Action’ e.g. a note, phone call, or appointment, to a customer. Each Action is recorded in the Actions Database Table.

For example, if creating an ‘Action’ with an action type of Appointment, the operator may select the description ‘Appointment’ from an operator-defined list of action types (recorded in the Actions Database Table). The GUI note screen will then allow the operator to select the date and time of the appointment from a system calendar and enter any Information about the relevant appointment.

Alternatively, the operator may create an action type of ‘Phone call’. In this case, the GUI note screen will display a list of contact people associated with this customer and their telephone numbers (recorded in the Contacts Database Table). The operator selects the appropriate contact person and enters information regarding the telephone conversation. The operator may also assign a status to the phone call action, such as ‘Customer Busy’, ‘Left Message’ or ‘No Answer’.

The operator also has the ability to utilise a ‘Timer’ function in conjunction with each action. For example, if creating an action type of Phone call, the operator can click on the Timer icon displayed on the Action—Phone call GUI screen to start the Timer to record the length of the phone call and assign this time to the action. The Timer can also be used to time appointments, meetings or time spent working on a customer's contract for billing out purposes.

Operators also have the ability to assign an action type of ‘Note’ to a customer and a customer's quotation/contract. The Local Merchant Application creates two types of notes; operator notes and system notes. Operator notes are created by an operator using the Local Merchant Application. Recorded with each operator note is the customer's unique ID code, the operator's User ID and the date and time that the note is created. System notes are created automatically by the Local Merchant Application and act as an audit log of the customer's record. Each time the customer's record is modified, e.g. a payment method for the customer is altered, the details of the modification are recorded along with the User ID of the operator who performed the modification and the date and time the modification was performed. Although all operator and system notes are recorded in the Actions Database Table, only operator notes are able to be viewed on the Local Merchant Application.

The data stored in the Actions Database Table of each Local Merchant Application is replicated in the Master Actions Database Table stored on the Remote Host Application. The Remote Host Operator is able to view both operator and system notes.

The Invention incorporates a feature named Messaging, which enables operators of each Local Merchant Application and the Remote Host Application to create, send and store messages to customers and contacts recorded in the application in multiple formats known as notification types e.g. short message service [SMS], email, and letter.

Messages are created in the system by means of GUI data entry screens, allowing the Merchant to enter the text of the message into a number of individual message creation screens e.g. the Create New SMS Message screen. Merchants may create single messages or a group of bulk messages which can be sent to a range of customers by ‘filtering’ the contact and marketing Information stored for each customer.

Messages can also be created quickly by using pre-set message templates (recorded in the Message Template Database Table). For example, in the case of a standard email sent to customers every month, the Merchant simply selects a standard email template recorded in the Message Template Database Table and the text is automatically inserted by the application.

The Merchant may also insert a range of merge fields from the database tables into the text of messages in order to personalise messages. Merge fields are available for every field in every database table e.g. the Customer Table and the Contracts Table. For example, by inserting the merge field <FIRST NAME> into an email message, the application will automatically insert the customer's first name.

Messages can also be automatically created and sent by utilising message triggers which are linked to key dates. Message triggers facilitate event driven message creation, for example, a message trigger can be used to automatically create and send a contract expiry message to the customer on a particular date. Merchants can create single or bulk message triggers for customers and these are recorded in the Message Triggers Database Table).

Each message created or received is assigned a Mailbox ID which cross references the Mailbox Database Table. The Mailbox Database Table is represented by a GUI list screen which arranges and displays the messages recorded in the Message Database Table according to the Mailbox ID they have been assigned e.g. In, Out, Pending, Archived, Host, etc., allowing the Merchant to quickly view, search and recall each message recorded in the Message Database Table.

The Messages Database Table stores the details of every message which has been sent to or received from a customer or sent to or received from the Remote Host Application, such as the message ID, customer ID, user ID of the operator who created the message, message/notification type (e.g. sms, email, letter), mailbox ID (cross references the Mailbox Database Table), message template ID (cross references the Message Template Database Table), message trigger ID (cross references the Message Trigger Database Table) date and time sent and message status (e.g. pending, sent, rejected, received).

The data stored in the Messages Database Table of each Local Merchant Application is replicated in the Master Messages Database Table stored on the Remote Host Application.

The Message Template Database Table Messages stores all the pre-set message templates created on the Local Merchant Application. For example, in the case of a standard email sent to customers every month, the Merchant simply selects a standard email template recorded in the Message Template Database Table and the text is automatically inserted by the application.

The data stored in the Message Template Database Table of each Local Merchant Application is replicated in the Master Message Template Database Table stored on the Remote Host Application.

The Message Trigger Database Table stores all the pre-set message triggers which have been created for customers and are linked to key dates. Message triggers facilitate event driven message creation, for example, a message trigger can be used to automatically create and send a contract expiry message to the customer on a particular date. Merchants can create single or bulk message triggers for customers and these are recorded in the Message Triggers Database Table.

The data stored in the Message Triggers Database Table of each Local Merchant Application is replicated in the Master Message Triggers Database Table stored on the Remote Host Application.

The Mailbox Database Table stores the unique mailbox ID and the type of each mailbox created on the Local Merchant Application. Each message created or received is assigned to one of the Mailbox ID's recorded in the Mailbox Database Table. The Mailbox Database Table is represented by a GUI list screen which arranges and displays the messages recorded in the Message Database Table according to the Mailbox ID they have been assigned e.g. In, Out, Pending, Archived, Host, etc., allowing the Merchant to quickly view, search and recall each message recorded in the Message Database Table.

The data stored in the Mailbox Database Table of each Local Merchant Application is replicated in the Master Mailbox Database Table stored on the Remote Host Application.

The system can incorporate a function named ‘Task Manager’. The Task Manager is an automated ‘To Do’ list and notifies the Merchant of tasks which are due, yet to be completed or outstanding. The Task Manager is not linked to a particular database table, but instead obtains information from many database tables and converts the records from these tables into a GUI list screen, allowing the Merchant to view the outstanding tasks and take action.

For example, on a daily basis the Task Manager functionality sweeps the database tables and locates all quotations and contracts which are awaiting completion and displays these in the Task Manager GUI list, along with a visual display of the status and outstanding task for each quotation and contract e.g. Contract Printed, DDR Signed, Awaiting Host Response, etc. The Task Manager functionality also locates any prospects which are due to be contacted, or customers who have quotations or contracts which are about to expire. In addition, any messages which are due to be sent on this day are also located and displayed in the Task Manager GUI list screen.

To further exemplify the above description reference is made to the figures.

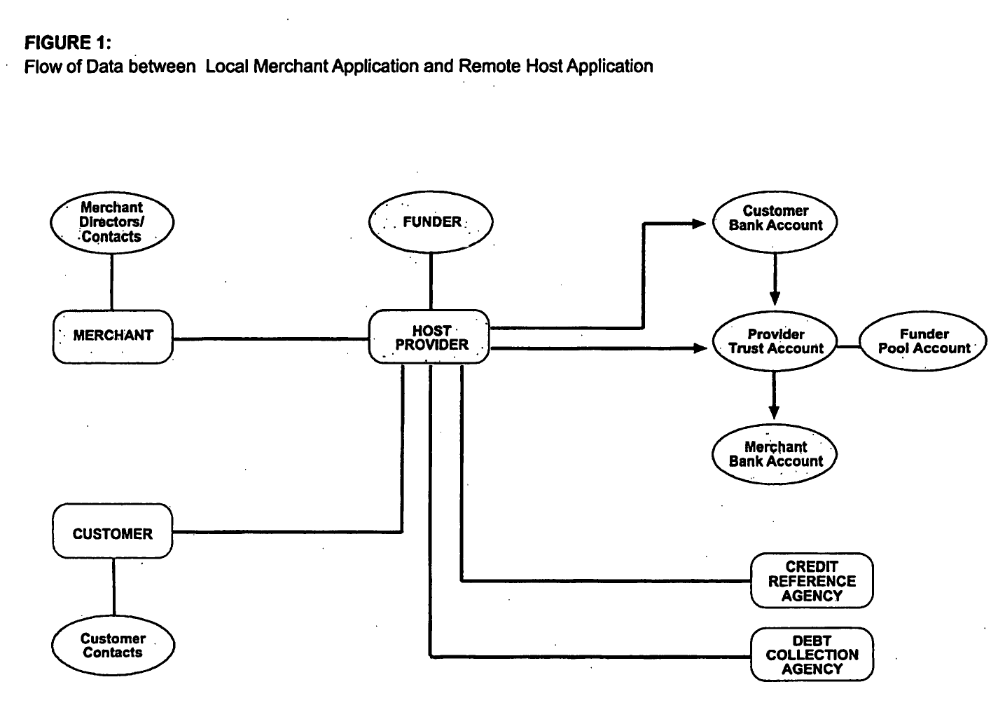

In order to process contracts, as demonstrated in FIG. 1, the merchant 1 enters into a service agreement with the operator of the system 2 to process and manage contracts created by the merchant, and also enters into an agreement with one or more funding providers 3 for an agreed funding limit. Note, the operator of the system 2 may also be the funding provider 3.

Under this agreement, the merchant 1 may indemnify the funding provider or providers 3 from any losses arising from the provision of financing to the merchant's clients. The funding provider 3 may seek security for the agreed funding limit by obtaining fixed and floating charges on the assets of the merchant and/or directors/partners, personal guarantees and/or mortgages on property owned by directors/partners/merchant 4.

The consumer 5 engages the merchant 1 to provide goods and/or services. The merchant 1 offers the consumer 5 the provision of an amortised finance contract for settlement of payment.

When processing a consumer's contract, the merchant 1 can nominate which funder will fund the consumer's contract, based upon the consumer's credit worthiness and established lending rules and criteria. For example, if the loan amount exceeds or falls below the set lending amount established by a particular funder, the merchant may select another funder to fund the contract (providing the merchant has a funding agreement with multiple funders).

The consumer 5 enters into a contract with the nominated funding provider 3 for the value of the merchant's invoice, plus any additional document fees, finance rates/interest, commission and stamp duty if desired. The total amount is then amortised into monthly re-payments over a set period e.g. 10 months.

The operator of the system 2 may perform a series of velocity error checks on the consumer's credit worthiness, the merchants current facility limit, the consumer's existing credit limit, etc. and either approve or decline the finance contract. The consumers creditworthiness may also be checked with a known credit reference agency.

Once the contract is funded, the operator of the system 2 is responsible for the settlement, collection and management of the contract, Including informing the merchant 1 and the consumer 5 of any failed payments. In the event of a default on the contract by the consumer 5; collection and recovery of the loan is the responsibility of the operator of the invention 2, however the merchant 1 is liable for any losses as the merchant 1 is acting as guarantor for the consumer 5.

Once the contract is approved, the operator of the system 2 performs an automated direct debit from the consumer's bank account 6 for the first scheduled contract payment, depositing the funds into the funding provider's bank account 7.

If the initial direct debit is processed successfully and the funds clear (i.e. the consumer does not default on payment), the operator of the system 2 settles the principle amount of the contract, minus any optional fees, charges and bad debt offsets that may apply, directly to the merchant's account 8.

The ongoing collection of scheduled contract payments, management of rejected payments and cancellation of defaulted contracts in accordance with an embodiment of the Invention will also be explained by reference to the figures.

Preferably on the date of each scheduled contract payment, the operator of the system 2 performs an automated direct debit from the consumer's bank account 6 for the amount of the scheduled contract payment, depositing the funds into the funding provider's bank account 7. Every successful payment reduces the consumer's overall contract balance owing to the funding provider 3 and increases the merchant's available funding facility balance for the funding of new contracts.

In the event that a scheduled contract payment defaults, then ideally the operator of the system 2 notifies the consumer 5 and the merchant 1 and the payment is re-scheduled. If, after a number of agreed payment attempts, the contract payment remains in default and the consumer 5 has not finalised the arrears, the operator of the system notifies the consumer 5 and the merchant 1 that the contract is to be cancelled. A further period is allowed for the consumer 5 to provide ‘cleared funds’ or come to an agreement for a ‘payment plan’. If this is not achieved, the contract is cancelled.

The operator of the system 2 notifies the credit reference agency 9 of the defaulting consumer 5 and the default contract amount is recorded on the consumer's public credit file with a credit reference agency 9.

The operator of the system 2 notifies the merchant 1 that the defaulting consumer 5 has been referred for debt collection. The operator of the system 2 changes the contract's status from ‘current’ to ‘defaulted’. The principle amount of the outstanding contract (total outstanding, less fees and charges) is allocated as outstanding and that amount is deducted from the balance of the merchant's available funding facility until the matter is resolved.

The operator of the system 2 refers the defaulting consumer 5 to a debt collection agency 10. If the outstanding balance of the contract is collected from the defaulting consumer 5 in full, the operator of the system 2 changes the contract's status to ‘finalised’ and notifies the merchant 1. The merchant's available funding facility balance is also changed to reflect the payment.

If the debt collection agency 10 is unsuccessful in collecting the outstanding balance of the contract from the defaulting consumer 5 or there is a shortfall, the operator of the system 2 notifies the merchant 1. The outstanding balance of the contract, or the shortfall, is then offset against the merchant's next contract settlement, or alternatively, a direct debit transaction is performed, deducting the outstanding amount from the merchant's bank account 8 and depositing the funds Into the funding providers bank account 9, under the terms of the agreement between the merchant 1 and the funding provider 3.

It will be understood that the system, in its present form, can be adapted to suit other financial services, industries and products such as Residential Mortgages and Receivables Funding, as required.

Traditional contract funding systems utilise either costly, time consuming manual systems, or antiquated computerised systems with limited flexibility in document generation, payment methods and reporting options. These problems are overcome by the present invention. The invention is a new system which electronically automates the entire contract funding process using unique ‘store and forward’ technology. The invention effectively removes the manual management and processing of an operator's contract funding business and offers the operator the ability to offer multiple funding products via the one application.

1. A consumer credit finance cashflow funding system including a local processor operable by a broker, said local processor including an input means to allow said broker to input data in respect of a funding request, and said local processor analysing said data using predefined rules to determine whether funding will be offered in response to said funding request; wherein said local processor synchronises data with a central processor; and wherein when said funding is accepted said system performs electronic settlement of contracts and payment schedules.

2. A system as claimed in claim 1, wherein when said local processor synchronises with said central processor, said central processor performs settlement of said funding request.

3. A system as claimed in claim 1, wherein following a failed payment said system creates default fees and performs automatic resubmissions.

4. A system as claimed in claim 1 wherein said system forwards delinquent accounts to a debt collection service and notifies all stakeholders.

5. A system as claimed in claim 1 wherein data stored on said local processor is replicated on said central processor.

6. A system as claimed in claim 1, wherein the synchronising of data includes transmission of the data including a header packet to authenticate and validate said data.

7. A system as claimed in claim 6, wherein said data also includes database table and record identification codes.

8. A system as claimed in claim 1 wherein when said funding is accepted said system sources said funding from a plurality of funders.

9. A system as claimed in claim 8 wherein said system generates, processes and manages funding contracts for said plurality of funders in order to provide said funding.

10. A system as claimed in claim 2, wherein following a failed payment said system creates default fees and performs automatic resubmissions.

11. A system as claimed in claim 2 wherein said system forwards delinquent accounts to a debt collection service and notifies all stakeholders.

12. A system as claimed in claim 3, wherein said system forwards delinquent accounts to a debt collection service and notifies all stakeholders.

13. A system as claimed in claim 2, wherein data stored on said local processor is replicated on said central processor.

14. A system as claimed in claim 3, wherein data stored on said local processor is replicated on said central processor.

15. A system as claimed in claim 4, wherein data stored on said local processor is replicated on said central processor.

16. A system as claimed in claim 2, wherein the synchronising of data includes transmission of the data including a header packet to authenticate and validate said data.

17. A system as claimed in claim 3, wherein the synchronising of data includes transmission of the data including a header packet to authenticate and validate said data.

18. A system as claimed in claim 4, wherein the synchronising of data includes transmission of the data including a header packet to authenticate and validate said data.

19. A system as claimed in claim 5, wherein the synchronising of data includes transmission of the data including a header packet to authenticate and validate said data.
